(19) United States
(12) Patent Application Publication
(10) Pub. No.: US 2018/0246384 A1
(43) Pub. Date: Aug. 30, 2018

(54) LIQUID CRYSTAL DISPLAY PANEL AND LIQUID CRYSTAL DISPLAY APPARATUS HAVING THE SAME

(71) Applicant: Shenzhen China Star Optoelectronics Semiconductor Display Technology Co., Ltd., Shenzhen (CN)

(72) Inventor: Sikun HAO, Shenzhen (CN)

(21) Appl. No.: 15/524,658

(22) PCT Filed: Mar. 17, 2017
(86) PCT No.: PCT/CN2017/077095

§ 371 Date: May 5, 2017

(30) Foreign Application Priority Data
Feb. 24, 2017 (CN) 201710103826.4

(51) Int. Cl. G02F 1/1362; G02F 1/1335; G02F 1/1368; G02F 1/1337; G02F 1/137

(52) U.S. Cl. CPC G02F 1/136286; G02F 1/133514; G02F 1/1368; G02F 2201/123; G02F 1/133707; G02F 1/137; G02F 1/136213

(57) ABSTRACT

The present invention provides a liquid crystal display panel having: a plurality of odd-numbered row pixels and a plurality of even-numbered row pixels that are alternately arranged. A voltage value of a pixel electrode to which the odd-numbered row pixels or the even-numbered row pixels correspond is adjusted so as to form different polar angles of liquid crystal molecules at the odd-numbered row pixels and the even-numbered row pixels. The beneficial effect of the is that, in the liquid crystal display panel, the polar angles of liquid crystal molecules in the adjacent row pixels are different to solve the technical problem of color-shift at large viewing angles.

### BACKGROUND OF THE INVENTION

### Field of the Invention

The present invention relates to the technical field of liquid crystal display technology, and more particularly to a liquid crystal display panel and a liquid crystal display apparatus having the same.

### Description of the Related Art

A liquid crystal display (LCD) with advantages such as lightweight and thin-structure has gradually become one of the fastest developing flat-panel display devices. However, compared with a cathode ray tube display, the viewing angle of a thin-film transistor LCD is relatively narrow, which greatly limits the possible applications in the technical field of high-end display with strict requirements of viewing angle, such as aerospace technology or medical technology. With the fast development of wide-viewing angle technology in the technical field of LCD, currently there are many products with a viewing-angle characteristic that is able to reach 85 degrees or even larger for both the horizontal viewing angle and the vertical viewing angle or even larger degrees.

Currently, a wide-viewing angle technology of LCDs is mainly divided into two types: Multi-domain Vertical Alignment (MVA) and In Plane Switching (IPS). The Multi-domain Vertical Alignment type has high contrast in frontal view which can usually reach 4000:1 and more. The IPS technology forms parallel and repeatedly distributed pixel electrodes and common electrodes liquid crystal molecules twist on a TFT array substrate, liquid crystal molecules to make liquid crystal molecules twist under a horizontal electric field, thereby providing a wide-viewing angle but with a relatively low contrast that is usually lower than 2000:1.

However, for a multi-domain vertical alignment type panel, the display image thereof will have a decreased contrast and a color-shift problem when watching at a large viewing angle, thereby leading to a poor display effect.

### SUMMARY OF THE INVENTION

The present invention provides a liquid crystal display panel, wherein the polar angles of liquid crystal molecules in two adjacent rows of pixels in a multi-domain vertical alignment type liquid crystal display panel are different, which solves a technical problem that the display image of a conventional multi-domain vertical alignment type panel has a decreased contrast and a color-shift problem when watching at a large viewing angle, thereby leading to a poor display effect.

In order to solve the foregoing problem, the technical solution provided by the present invention is as follows:

The present invention provides a liquid crystal display panel including:

an array substrate;

a color-filter substrate being mounted opposite to the array substrate;

a liquid crystal layer being disposed between the array substrate and the color-filter substrate;

the array substrate has a plurality of data lines, a plurality of scanning lines and a plurality of pixel units formed by crossing of the scanning lines and the data lines;

wherein, each of the pixel units includes at least one odd-numbered row pixel and at least one even-numbered row pixel being alternately arranged; a voltage value of a pixel electrode to which the odd-numbered row pixels or the even-numbered row pixels correspond is adjusted so as to form different polar angles of liquid crystal molecules at the odd-numbered row pixels and the even-numbered row pixels;

the odd-numbered row pixels and the even-numbered row pixels form a display image having alternately-arranged brightness and darkness.

According to a preferred embodiment of the present invention, the voltage value of the pixel electrode to which the odd-numbered row pixels or the even-numbered row pixels correspond is raised.

According to a preferred embodiment of the present invention, the odd-numbered row pixel includes a first thin-film transistor; the even-numbered row pixel includes a second thin-film transistor; wherein a channel length of the first thin-film transistor is greater than that of the second thin-film transistor; a width of the channel of the first thin-film transistor is greater than that of the second thin-film transistor.

According to a preferred embodiment of the present invention, the odd-numbered row pixel further includes a first sharing capacitor and a second sharing capacitor; the first sharing capacitor and the second sharing capacitor are connected to each other; another end of the first sharing capacitor is connected to a pixel electrode of a sub-pixel; another end of the second sharing capacitor is connected to a pixel electrode of next sub-pixel.

the voltage value of the pixel electrode to which the odd-numbered row pixels or the even-numbered row pixels correspond is lowered.

According to a preferred embodiment of the present invention, the odd-numbered row pixel includes a first thin-film transistor; the even-numbered row pixel includes a second thin-film transistor and a third thin-film transistor; wherein a source of the third thin-film transistor is connected to a pixel electrode; a gate of the third thin-film transistor is connected to a corresponding scanning line; a drain of the third thin-film transistor is connected to a common line of a preceding pixel.

According to a preferred embodiment of the present invention, a channel of the first thin-film transistor and that of the second thin-film transistor have the same size; a length of a channel of the third thin-film transistor is less than the length of the channel of the first thin-film transistor and the length of the channel of the second thin-film transistor; a width of the channel of the third thin-film transistor is less than the width of the channel of the first thin-film transistor and the width of the channel of the second thin-film transistor.

The present invention further provides a liquid crystal display panel including:

an array substrate;

a color-filter substrate being mounted opposite to the array substrate;

a liquid crystal layer being disposed between the array substrate and the color-filter substrate;

the array substrate has a plurality of data lines, a plurality of scanning lines and a plurality of pixel units formed by crossing of the scanning lines and the data lines;

wherein, each of the pixel units includes at least one odd-numbered row pixel and at least one even-numbered row pixel being alternately arranged; a voltage value of a pixel electrode to which the odd-numbered row pixels or the even-numbered row pixels correspond is adjusted so as to form different polar angles of liquid crystal molecules at the odd-numbered row pixels and the even-numbered row pixels.

According to a preferred embodiment of the present invention, the voltage value of the pixel electrode to which the odd-numbered row pixels or the even-numbered row pixels correspond is raised.

According to a preferred embodiment of the present invention, the odd-numbered row pixel includes a first thin-film transistor; the even-numbered row pixel includes a second thin-film transistor; wherein a channel length of the first thin-film transistor is greater than that of the second thin-film transistor; a width of the channel of the first thin-film transistor is greater than that of the second thin-film transistor.

According to a preferred embodiment of the present invention, the odd-numbered row pixel further includes a first sharing capacitor and a second sharing capacitor; the first sharing capacitor and the second sharing capacitor are connected to each other; another end of the first sharing capacitor is connected to a pixel electrode of a sub-pixel; another end of the second sharing capacitor is connected to a pixel electrode of next sub-pixel.

the voltage value of the pixel electrode to which the odd-numbered row pixels or the even-numbered row pixels correspond is lowered.

According to a preferred embodiment of the present invention, the odd-numbered row pixel includes a first thin-film transistor; the even-numbered row pixel includes a second thin-film transistor and a third thin-film transistor; wherein a source of the third thin-film transistor is connected to a pixel electrode; a gate of the third thin-film transistor is connected to a corresponding scanning line; a drain of the third thin-film transistor is connected to a common line of a preceding pixel.

According to a preferred embodiment of the present invention, a channel of the first thin-film transistor and that of the second thin-film transistor have the same size; a length of a channel of the third thin-film transistor is less than the length of the channel of the first thin-film transistor and the length of the channel of the second thin-film transistor; a width of the channel of the third thin-film transistor is less than the width of the channel of the first thin-film transistor and the width of the channel of the second thin-film transistor.

According to the foregoing object of the present invention, a liquid crystal display apparatus is disclosed. The liquid crystal display apparatus includes:

a liquid crystal display panel;

a backlight module being mounted on a back of the liquid crystal display panel;

the liquid crystal display panel has:

an array substrate;

a color-filter substrate being mounted opposite to the array substrate;

a liquid crystal layer being disposed between the array substrate and the color-filter substrate;

the array substrate has a plurality of data lines, a plurality of scanning lines and a plurality of pixel units formed by crossing of the scanning lines and the data lines;

wherein, each of the pixel units includes at least one odd-numbered row pixel and at least one even-numbered row pixel being alternately arranged; a voltage value of a pixel electrode to which the odd-numbered row pixels or the even-numbered row pixels correspond is adjusted so as to form different polar angles of liquid crystal molecules at the odd-numbered row pixels and the even-numbered row pixels.

According to a preferred embodiment of the present invention, the voltage value of the pixel electrode to which the odd-numbered row pixels or the even-numbered row pixels correspond is raised.

According to a preferred embodiment of the present invention, the odd-numbered row pixel includes a first thin-film transistor; the even-numbered row pixel includes a second thin-film transistor; wherein a channel length of the first thin-film transistor is greater than that of the second thin-film transistor; a width of the channel of the first thin-film transistor is greater than that of the second thin-film transistor.

the voltage value of the pixel electrode to which the odd-numbered row pixels or the even-numbered row pixels correspond is lowered.

According to a preferred embodiment of the present invention, the odd-numbered row pixel includes a first thin-film transistor; the even-numbered row pixel includes a second thin-film transistor and a third thin-film transistor; wherein a source of the third thin-film transistor is connected to a pixel electrode; a gate of the third thin-film transistor is connected to a corresponding scanning line; a drain of the third thin-film transistor is connected to a common line of a preceding pixel.

According to a preferred embodiment of the present invention, a channel of the first thin-film transistor and that of the second thin-film transistor have the same size; a length of a channel of the third thin-film transistor is less than the length of the channel of the first thin-film transistor and the length of the channel of the second thin-film transistor; a width of the channel of the third thin-film transistor is less than the width of the channel of the first thin-film transistor and the width of the channel of the second thin-film transistor.

According to a preferred embodiment of the present invention, the odd-numbered row pixel further includes a first sharing capacitor and a second sharing capacitor; the first sharing capacitor and the second sharing capacitor are connected to each other; another end of the first sharing capacitor is connected to a pixel electrode of a sub-pixel; another end of the second sharing capacitor is connected to a pixel electrode of next sub-pixel.

The beneficial effect of the present invention is: compared with the conventional liquid crystal display panel, the polar angles of liquid crystal molecules in two adjacent rows of pixels in the liquid crystal display panel of the present invention are different, which further forms an image of pixels with alternately-arranged bright rows and dark rows. Thus, the adjacent rows of pixels have higher contrast when watching at a large viewing angle, thereby solving the technical problem of color-shift at larger viewing angle.

### BRIEF DESCRIPTION OF THE DRAWINGS

In order to explain the technical solutions in the present embodiments or in the prior art more clearly, accompanying drawings required in the description of the present embodiments or prior art will be briefly described. Obviously, accompanying drawings are just some embodiments of the present disclosure, while other drawings may be obtained by those skilled in the art according to these drawings, without paying out any creative work.

FIG. 1 is a schematic diagram of a pixel structure of a liquid crystal display panel according to a first embodiment of the present invention;

FIG. 2 is a schematic diagram of a pixel structure of a liquid crystal display panel according to a second embodiment of the present invention; and

FIG. 3 is a schematic diagram of a pixel structure of a liquid crystal display panel according to a third embodiment of the present invention.

### DETAILED DESCRIPTION OF THE PREFERRED EMBODIMENTS

The foregoing objects, features and advantages adopted by the present invention can be best understood by referring to the following detailed description of the preferred embodiments and the accompanying drawings. Furthermore, the directional terms described in the present invention, such as upper, lower, front, rear, left, right, inner, outer, side and etc., are only directions referring to the accompanying drawings, so that the used directional terms are used to describe and understand the present invention, but the present invention is not limited thereto. In the drawings, similar structural units are designated by the same reference numerals.

For the technical problem that the display image of a conventional liquid crystal display panel has a decreased contrast and a color-shift phenomenon when watching at a large viewing angle, thereby leading to a poor display quality, the embodiment of the present invention is able to solve this defect.

The present invention provides a liquid crystal display panel which includes: an array substrate; a color-filter substrate being mounted opposite to the array substrate; a liquid crystal layer being disposed between the array substrate and the color-filter substrate; the array substrate has a plurality of data lines, a plurality of scanning lines and a plurality of pixel units formed by crossing of the scanning lines and the data lines; wherein, each of the pixel units includes at least one odd-numbered row pixel and at least one even-numbered row pixel being alternately arranged. After the data lines charges each pixel with data signals through the corresponding thin-film transistor, with the change of the structure of the pixels, a voltage value of a pixel electrode to which the odd-numbered row pixels or the even-numbered row pixels correspond is adjusted so that different polar angles of liquid crystal molecules are formed at the odd-numbered row pixels and the even-numbered row pixels, which means in two rows of pixels, a display image with one bright row and one dark row is formed, thereby enhancing the contrast of the image at large viewing angles.

### First Embodiment

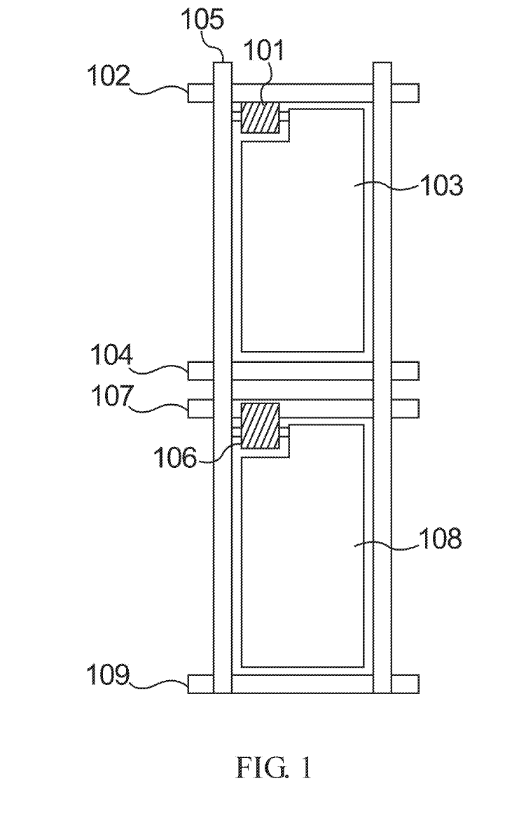

FIG. 1 is a schematic diagram of a pixel structure according to a first embodiment of the present invention.

As shown in FIG. 1, the embodiment of the present invention uses an odd-numbered row pixel and an even-numbered row pixel which are adjacent in a pixel unit as an example for description.

A sub-pixel of the odd-numbered row pixel includes a first thin-film transistor 101, a first scanning line 102, a first pixel electrode 103 and a first common line 104. The first common line 104 is substantially parallel with the first scanning line 102. The first pixel electrode 103 is disposed between the first scanning line 102 and the first common line 104. A data line 105 is perpendicularly crossed with the first scanning line 102 and the first common line 104. A gate of the first thin-film transistor 101 is connected to the first scanning line 102. A source of the first thin-film transistor 101 is connected to the data line 105. A drain of the first thin-film transistor 101 is connected to the first pixel electrode 103. A storage capacitor is formed between the first common line 104 and the first pixel electrode 103.

A sub-pixel of the even-numbered row pixel includes a second thin-film transistor 106, a second scanning line 107, a second pixel electrode 108 and a second common line 109. The specific positions and the connection relationship of each portion of the sub-pixel of the even-numbered row pixel are similar to the sub-pixel of the odd-numbered row pixel.

A size of a channel of the second thin-film transistor 106 is set to a general size. A size of a channel of the first thin-film transistor 101 is set to be larger than the size of the channel of the second thin-film transistor 106, wherein a length of the channel of the first thin-film transistor 101 is greater than the length of the channel of the second thin-film transistor 106. A width of the channel of the first thin-film transistor 101 is greater than the width of the channel of the second thin-film transistor 106.

The structure of other row pixels in the array substrate is a duplicate of the foregoing pixel structure.

By increasing the size of the channel of the first thin-film transistor 101, the voltage of the pixel electrode after being charged with the data signal through the first thin-film transistor 101 is relatively larger than that through a thin-film transistor having a channel with the general size, which causes a polar angle of liquid crystal molecules to which the odd-numbered row pixel corresponds is relatively larger than a polar angle of liquid crystal molecules to which the even-numbered row pixel corresponds, and therefore a display image with one bright row and one dark row is formed.

### Second Embodiment

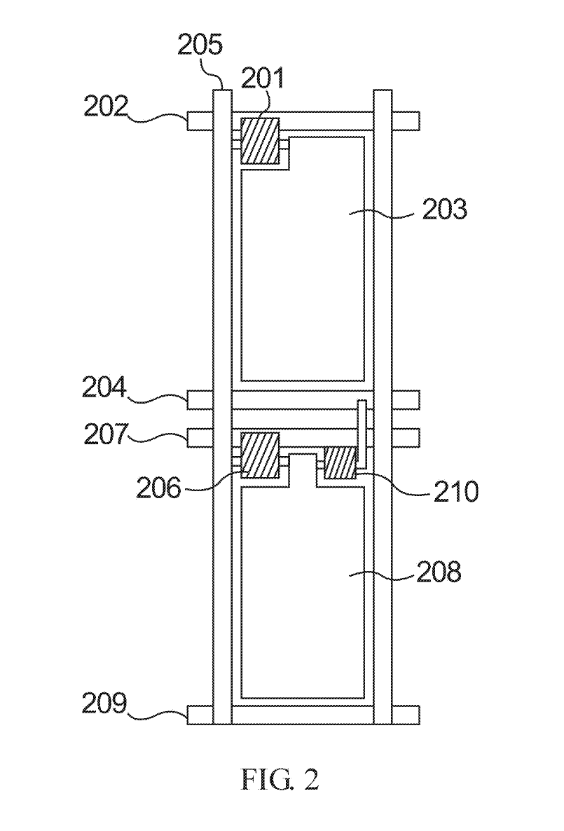

FIG. 2 is a schematic diagram of a pixel structure according to a second embodiment of the present invention.

As shown in FIG. 2, the embodiment of the present invention uses an odd-numbered row pixel and an even-numbered row pixel which are adjacent in a pixel unit as an example for description.

A sub-pixel of the odd-numbered row pixel includes a first thin-film transistor 201, a first scanning line 202, a first pixel electrode 203, and a first common line 204. The first common line 204 is substantially parallel with the first scanning line 202. The first pixel electrode 203 is disposed between the first scanning line 202 and the first common line 204. A data line 205 is perpendicularly crossed with the first scanning line 202 and the first common line 204. A gate of the first thin-film transistor 201 is connected to the first scanning line 202. A source of the first thin-film transistor 201 is connected to the data line 205. A drain of the first thin-film transistor 201 is connected to the first pixel electrode 203. A storage capacitor is formed between the first common line 204 and the first pixel electrode 203.

A sub-pixel of the even-numbered row pixel includes a second thin-film transistor 206, a second scanning line 207, a second pixel electrode 208, a second common line 209, and a third thin-film transistor 210. The second common line 209 is substantially parallel with the second scanning line 207. The second pixel electrode 208 is disposed between the second scanning line 207 and the first common line 204. A data line 205 is perpendicularly crossed with the second scanning line 207 and the second common line 209. A gate of the second thin-film transistor is connected to the second scanning line 207. A source of the second thin-film transistor 206 is connected to the data line 205. A drain of the second thin-film transistor 206 is connected to the second pixel electrode 208. A storage capacitor is formed between the second common line 209 and the second pixel electrode 208.

A gate of the third thin-film transistor 210 is connected to the second scanning line 207. A source of the third thin-film transistor 210 is connected to the second pixel electrode 208. A drain of the third thin-film transistor 210 is connected to the common line 204 of the odd-numbered row pixel.

The structure of other row pixels in the array substrate is a duplicate of the foregoing pixel structure.

Preferably, a size of a channel of the third thin-film transistor 210 is set to a general size. A size of a channel of the first thin-film transistor 201 and a size of a channel of the second thin-film transistor 206 are the same, and the sizes of the channel of the first thin-film transistor 201 and the channel of the second thin-film transistor 206 are larger than the general size.

The structure of other row pixels in the array substrate is a duplicate of the foregoing pixel structure.

In the even-numbered row pixel, the third thin-film transistor 210 is configured to have a share of the electric current received by the second pixel electrode 208 so as to reduce the voltage value of the second pixel electrode 208, such that a polar angle of liquid crystal molecules to which the even-numbered row pixel corresponds is different from a polar angle of liquid crystal molecules to which the odd-numbered row pixel corresponds, and therefore a display image with one bright row and one dark row is formed.

### Third Embodiment

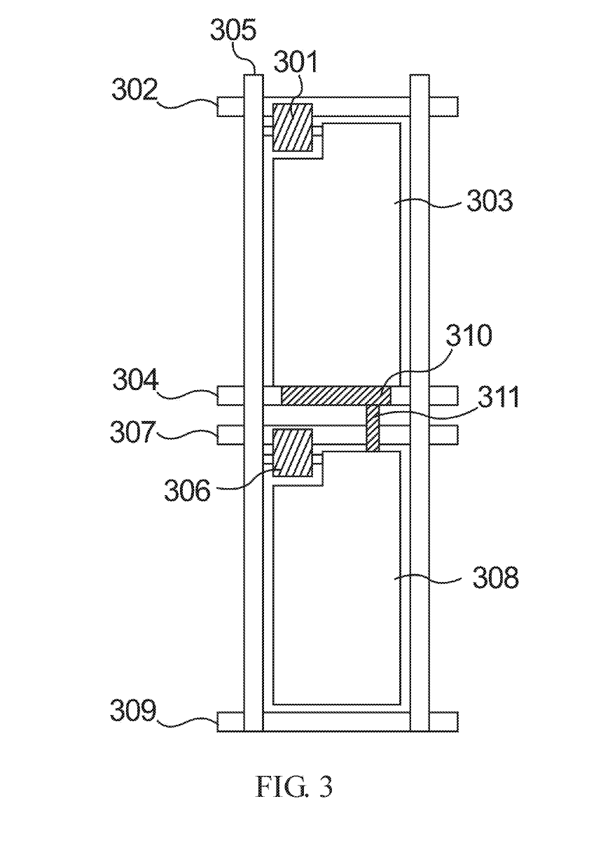

FIG. 3 is a schematic diagram of a pixel structure according to a second embodiment of the present invention.

As shown in FIG. 3, the embodiment of the present invention uses an odd-numbered row pixel and an even-numbered row pixel which are adjacent in a pixel unit as an example for description.

A sub-pixel of the even-numbered row pixel includes a second thin-film transistor 306, a second scanning line 307, a second pixel electrode 308, and a second common line 309. The second common line 309 is substantially parallel with the second scanning line 307. The second pixel electrode 308 is disposed between the second scanning line 307 and the second common line 309. A data line 305 is perpendicularly crossed with the second scanning line 307 and the second common line 309. A gate the second thin-film transistor 306 is connected to the second scanning line 307. A source of the second thin-film transistor 306 is connected to the data line 305. A drain of the second thin-film transistor 306 is connected to the second pixel electrode 308. A storage capacitor is formed between the second common line 309 and the second pixel electrode 308.

A sub-pixel of the odd-numbered row pixel includes a first thin-film transistor 301, a first scanning line 302, a first pixel electrode 303, and a first common line 304. The first common line 304 is substantially parallel with the first scanning line 302. The first pixel electrode 303 is disposed between the first scanning line 302 and the first common line 304. A data line 305 is perpendicularly crossed with the first scanning line 302 and the first common line 304. A gate the first thin-film transistor 301 is connected to the first scanning line 302. A source of the first thin-film transistor 301 is connected to the data line 305. A drain of the first thin-film transistor 301 is connected to the first pixel electrode 303. A storage capacitor is formed the first common line 304 and the first pixel electrode 303.

The odd-numbered row pixel further includes a first sharing capacitor 310 and a second sharing capacitor 311. The first sharing capacitor 310 and the second sharing capacitor 311 are connected to each other. Another end of the first sharing capacitor 310 is connected to the pixel electrode of the odd-numbered row pixel. Another end of the second sharing capacitor 311 is connected to the pixel electrode of the even-numbered row pixel.

When charging the even-numbered row pixel, the first sharing capacitor 310 and the second sharing capacitor 311 work together so as to raise the voltage value of the odd-numbered row pixel. A polar angle of liquid crystal molecules at the odd-numbered row pixel and the polar angle of liquid crystal molecules at the even-numbered row pixel then are different, which causes the odd-numbered row pixel and the even-numbered row pixel form a display image with one bright row and one dark row, thereby avoid a poor quality image having low contrast and color-shift phenomenon while watching the image at large viewing angles.

In accordance with the foregoing object of the present invention, a liquid crystal display apparatus is disclosed and includes: a liquid crystal display panel; a backlight module being mounted on a back of the liquid crystal display panel; the liquid crystal display panel has: an array substrate; a color-filter substrate being mounted opposite to the array substrate; a liquid crystal layer being disposed between the array substrate and the color-filter substrate; the array substrate has a plurality of data lines, a plurality of scanning lines and a plurality of pixel units formed by crossing of the scanning lines and the data lines; wherein, each of the pixel units includes at least one odd-numbered row pixel and at least one even-numbered row pixel being alternately arranged, a voltage value of a pixel electrode to which the odd-numbered row pixels or the even-numbered row pixels correspond is adjusted so as to form different polar angles of liquid crystal molecules at the odd-numbered row pixels and the even-numbered row pixels.

The work principle of the liquid crystal display apparatus of this preferred embodiment is the same as the work principle of the liquid crystal display panel of the foregoing preferred embodiment. Thus, it can be referred to the work principle of the liquid crystal display panel of the foregoing preferred embodiment and will not be described in detail herein to avoid redundancy.

The beneficial effect of the present invention is: compared with the conventional liquid crystal display panel, the polar angles of liquid crystal molecules in two adjacent rows of pixels in the liquid crystal display panel of the present invention are different, which further forms an image of pixels with alternately-arranged bright rows and dark rows. Thus, the adjacent rows of pixels have higher contrast when watching at a large viewing angle, thereby solving the technical problem of color-shift at larger viewing angle.

In conclusion, although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A liquid crystal display panel, comprising:
an array substrate;
a color-filter substrate being mounted opposite to the array substrate;
a liquid crystal layer being disposed between the array substrate and the color-filter substrate;
the array substrate has a plurality of data lines, a plurality of scanning lines and a plurality of pixel units formed by crossing of the scanning lines and the data lines;
wherein, each of the pixel units includes at least one odd-numbered row pixel and at least one even-numbered row pixel being alternately arranged, a voltage value of a pixel electrode to which the odd-numbered row pixels or the even-numbered row pixels correspond is adjusted so as to form different polar angles of liquid crystal molecules at the odd-numbered row pixels and the even-numbered row pixels;
the odd-numbered row pixels and the even-numbered row pixels form a display image having alternately-arranged bright rows and dark rows.

2. The liquid crystal display panel as claimed in claim 1, wherein the voltage value of the pixel electrode to which the odd-numbered row pixels or the even-numbered row pixels correspond is raised.

3. The liquid crystal display panel as claimed in claim 2, wherein the odd-numbered row pixel includes a first thin-film transistor; the even-numbered row pixel includes a second thin-film transistor; wherein a length of a channel of the first thin-film transistor is greater than that of the second thin-film transistor; a width of the channel of the first thin-film transistor is greater than that of the second thin-film transistor.

4. The liquid crystal display panel as claimed in claim 2, wherein the odd-numbered row pixel further includes a first sharing capacitor and a second sharing capacitor; the first sharing capacitor and the second sharing capacitor are connected to each other; another end of the first sharing capacitor is connected to a pixel electrode of a sub-pixel; another end of the second sharing capacitor is connected to a pixel electrode of next sub-pixel.

5. The liquid crystal display panel as claimed in claim 1, wherein the voltage value of the pixel electrode to which the odd-numbered row pixels or the even-numbered row pixels correspond is lowered.

6. The liquid crystal display panel as claimed in claim 5, wherein the odd-numbered row pixel includes a first thin-film transistor; the even-numbered row pixel includes a second thin-film transistor and a third thin-film transistor; wherein a source of the third thin-film transistor is connected to a pixel electrode; a gate of the third thin-film transistor is connected to a corresponding scanning line; a drain of the third thin-film transistor is connected to a common line of a preceding pixel.

7. The liquid crystal display panel as claimed in claim 6, wherein a channel of the first thin-film transistor and that of the second thin-film transistor have the same size; a length of a channel of the third thin-film transistor is less than the length of the channel of the first thin-film transistor and the length of the channel of the second thin-film transistor; a width of the channel of the third thin-film transistor is less than the width of the channel of the first thin-film transistor and the width of the channel of the second thin-film transistor.

8. A liquid crystal display panel, comprising:
an array substrate;
a color-filter substrate being mounted opposite to the array substrate;
a liquid crystal layer being disposed between the array substrate and the color-filter substrate;
the array substrate has a plurality of data lines, a plurality of scanning lines and a plurality of pixel units formed by crossing of the scanning lines and the data lines;
wherein, each of the pixel units includes at least one odd-numbered row pixel and at least one even-numbered row pixel being alternately arranged; a voltage value of a pixel electrode to which the odd-numbered row pixels or the even-numbered row pixels correspond is adjusted so as to form different polar angles of liquid crystal molecules at the odd-numbered row pixels and the even-numbered row pixels;
the odd-numbered row pixels and the even-numbered row pixels form a display image having alternately-arranged brightness and darkness.

9. The liquid crystal display panel as claimed in claim 8, wherein the voltage value of the pixel electrode to which the odd-numbered row pixels or the even-numbered row pixels correspond is raised.

10. The liquid crystal display panel as claimed in claim 9, wherein the odd-numbered row pixel includes a first thin-film transistor; the even-numbered row pixel includes a second thin-film transistor; wherein a length of a channel of the first thin-film transistor is greater than that of the second thin-film transistor; a width of the channel of the first thin-film transistor is greater than that of the second thin-film transistor.

11. The liquid crystal display panel as claimed in claim 9, wherein the odd-numbered row pixel further includes a first sharing capacitor and a second sharing capacitor; the first sharing capacitor and the second sharing capacitor are connected to each other; another end of the first sharing capacitor is connected to a pixel electrode of a sub-pixel; another end of the second sharing capacitor is connected to a pixel electrode of next sub-pixel.

12. The liquid crystal display panel as claimed in claim 8, wherein the voltage value of the pixel electrode to which the odd-numbered row pixels or the even-numbered row pixels correspond is lowered.

13. The liquid crystal display panel as claimed in claim 12, wherein the odd-numbered row pixel includes a first thin-film transistor; the even-numbered row pixel includes a second thin-film transistor and a third thin-film transistor; wherein a source of the third thin-film transistor is connected to a pixel electrode; a gate of the third thin-film transistor is connected to a corresponding scanning line; a drain of the third thin-film transistor is connected to a common line of a preceding pixel.

14. The liquid crystal display panel as claimed in claim 13, wherein a channel of the first thin-film transistor and that of the second thin-film transistor have the same size; a length of a channel of the third thin-film transistor is less than the length of the channel of the first thin-film transistor and the length of the channel of the second thin-film transistor; a width of the channel of the third thin-film transistor is less than the width of the channel of the first thin-film transistor and the width of the channel of the second thin-film transistor.

15. A liquid crystal display apparatus, comprising:
a liquid crystal display panel;
a backlight module being mounted on a back of the liquid crystal display panel;
the liquid crystal display panel has:
an array substrate;
a color-filter substrate being mounted opposite to the array substrate;
a liquid crystal layer being disposed between the array substrate and the color-filter substrate;
the array substrate has a plurality of data lines, a plurality of scanning lines and a plurality of pixel units formed by crossing of the scanning lines and the data lines;
wherein, each of the pixel units includes at least one odd-numbered row pixel and at least one even-numbered row pixel being alternately arranged; a voltage value of a pixel electrode to which the odd-numbered row pixels or the even-numbered row pixels correspond is adjusted so as to form different polar angles of liquid crystal molecules at the odd-numbered row pixels and the even-numbered row pixels.

16. The liquid crystal display apparatus as claimed in claim 15, wherein the odd-numbered row pixel includes a first thin-film transistor; the even-numbered row pixel includes a second thin-film transistor; wherein a length of a channel of the first thin-film transistor is greater than that of the second thin-film transistor; a width of the channel of the first thin-film transistor is greater than that of the second thin-film transistor.

17. The liquid crystal display apparatus as claimed in claim 15, wherein the odd-numbered row pixel further includes a first sharing capacitor and a second sharing capacitor; the first sharing capacitor and the second sharing capacitor are connected to each other; another end of the first sharing capacitor is connected to a pixel electrode of a sub-pixel; another end of the second sharing capacitor is connected to a pixel electrode of next sub-pixel.
